(19) United States
(12) Patent Application Publication
(10) Pub. No.: US 2008/0056723 A1
(43) Pub. Date: Mar. 6, 2008

(54) Multiple access free space laser communication method and apparatus

(76) Inventors: Randy Clinton Giles, Whippany, NJ (US); Alex Pidwerbetsky, Randolph, NJ (US); Roland Ryf, Aberdeen, NJ (US); Howard Roy Stuart, East Windsor, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/199,930

(22) Filed: Aug. 9, 2005

(51) Int. Cl. H04B 10/00

(52) U.S. Cl. 398/118

(57) ABSTRACT

An optical system may be configured as a receiving or as a transmitting system. As a receiving system, it is configured to receive at least one incident laser beam and project the beam into a spot on an array of actuable elements. The position of the spot is determined by the incident angular direction of the beam. The array is configured to track the position of the spot and at each tracked position of the spot to direct the beam onto an actual element. The actuable element tracks the spot so as to direct the beam onto a fixed path toward an optical receiver. As a transmitting system, it includes an actuable element configured to direct the light output from a laser into a spot on an array of actuable elements. The array is configured to track the position of the spot and at each tracked position of the spot to direct the light into a beam-forming system. The beam-forming system is configured to project the light in a transmitted beam having a variable angular direction. The beam angular direction is determined by the position of the spot on the array.

### FIELD OF THE INVENTION

This invention relates to systems and methods of free-space optical communication.

### ART BACKGROUND

In free-space optical communication, laser beams are modulated with data and transmitted to receivers through an unconfined propagation medium such as the atmosphere or outer space.

A typical optical system for transmitting and receiving free-space communications is configured as a telescope. An incoming laser beam is collected by the telescope optics and directed into, e.g., an optical fiber. The optical fiber guides the received light to an optical receiver for demodulation and detection. For transmission, the reception process may be reversed. That is, modulated light output from a laser is guided by an optical fiber to the telescope optics, which form the modulated light into a beam for transmission into, e.g., the atmosphere.

One of the technical difficulties that need to be overcome in a practical station for free-space optical-communication-is the need for tracking the received laser beam. The need for tracking may arise, for example, because there is relative motion between the transmitting and receiving stations, or because perturbations in the optical refractivity of the propagation medium cause the transmitted beams to be deflected.

Methods for tracking a received laser beam have, in fact, been successfully used. In systems of the prior art, however, an aperture for optical reception is typically dedicated to only one received beam at a time. Thus, for example, if multiple beams are tracked simultaneously, the full available aperture may need to be subdivided, and each subdivision allocated to one of the tracked beams. As the aperture available for receiving a given beam is reduced, however, the signal-to-noise ratio may be degraded.

Thus, there remains a need for an optical system which is capable of tracking multiple beams while maintaining a relatively large effective aperture with respect to all of the tracked beams.

### SUMMARY OF THE INVENTION

We have invented such an optical system.

In a broad aspect, our optical system is configured to receive at least one incident laser beam and project the beam into a spot on an array of actuable elements. The position of the spot is determined by the incident angular direction of the beam. The array is configured to track the position of the spot and at each tracked position of the spot to direct the beam onto an actuable element. The actuable element tracks the spot so as to direct the beam onto a fixed path toward an optical receiver.

In a second broad aspect, our optical system is configured to transmit at least one laser beam. In accordance with such second aspect, our system includes an actuable element configured to direct the light output from a laser into a spot on an array of actuable elements. The array is configured to track the position of the spot and at each tracked position of the spot to direct the light into a beam-forming system. The beam-forming system is configured to project the light in a transmitted beam having a variable angular direction. The beam angular direction is determined by the position of the spot on the array.

In specific embodiments of the invention, the array is a two-dimensional spatial light modulator (SLM) array. The actuable elements of the array may be, e.g., phase-shifting liquid crystals (LCs) or mechanically displaceable mirrors. Mirror arrays useful in this regard may be made, for example, by Micro Electrical Mechanical System (MEMS) technology. MEMS mirrors may be displaceable solely in the “piston” direction perpendicular to the plane of the array, or they may additionally be tiltable about one or two independent axes parallel to the array.

In specific embodiments of the invention, the elements of the array are configured to define, in use, a converging or diverging optical element that substantially intercepts each spot that is being tracked. Actuation of the elements is carried out such that the defined optical element remains with its spot as the spot moves across the array.

### BRIEF DESCRIPTION OF THE DRAWING

FIG. 1 is a schematic optical diagram, at a conceptual level and not to scale, of an exemplary optical system as described here. p FIG. 2 is an optical ray diagram, not to scale, illustrating some of the principles of operation of the optical system of FIG. 1.

FIG. 3 is an optical ray diagram illustrating further principles of operation of the optical system of FIG. 1, including the formation of steered beams by a mirror array. FIG. 3 is drawn at a conceptual level and is not to scale.

FIG. 4 is an optical ray diagram illustrating further principles of operation of the optical system of FIG. 1, including optical coupling of a steered beam into a lensed optical fiber. FIG. 3 is drawn at a conceptual level and is not to scale.

FIG. 5 is partly a ray diagram and partly a block diagram illustrating further principles of operation of the optical system of FIG. 1, including the use of a CCD camera and a sensor array as sources of control data. FIG. 5 is drawn at a conceptual level and is not to scale.

FIG. 6 is a functional block diagram illustrating an exemplary control scheme for using the optical system of FIG. 1 to receive optical signals from external targets.

FIG. 7 is a functional block diagram illustrating an exemplary control scheme for using the optical system of FIG. 1 to transmit optical signals to external targets.

### DETAILED DESCRIPTION

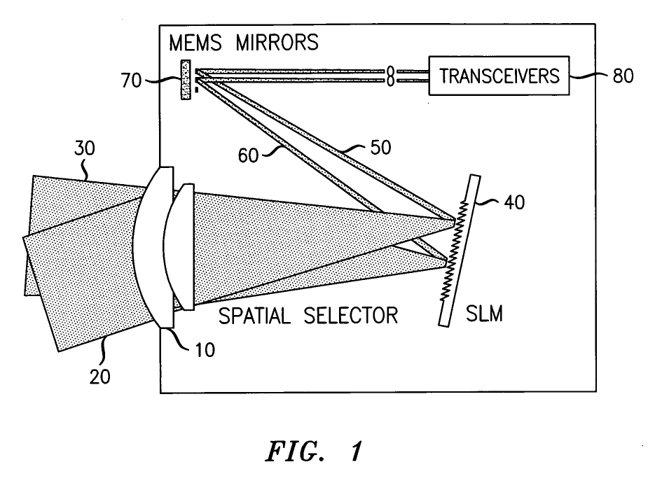

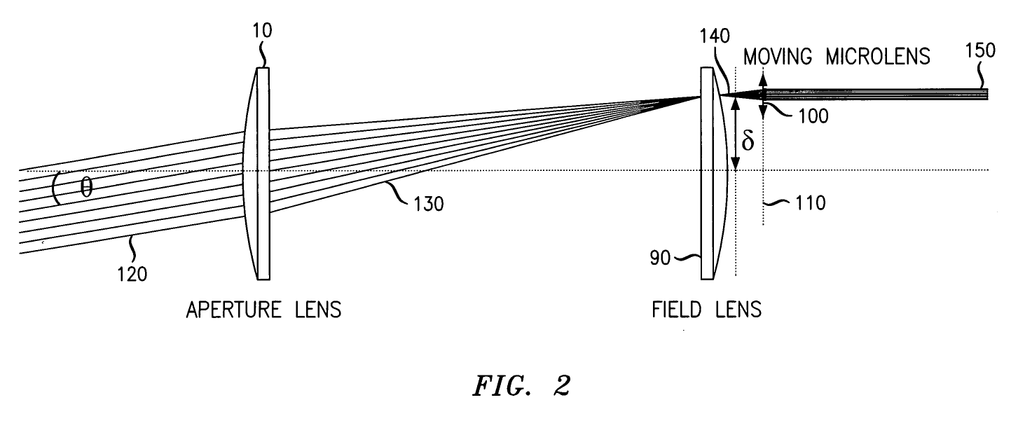

In the high-level view represented by FIG. 1, aperture lens 10 accepts beams 20 and 30, which enter the optical system from respective, remote targets, which are not shown in the figure. Aperture lens 10, typically acting together with other optical elements not shown in the figure, projects each beam into a respective spot on a spatial light modulator (SLM) array 40.

It should be noted that the number of beams represented in FIG. 1 has been chosen to be two solely for purposes of illustration. The optical system of FIG. 1 may be operated with as few as one beam, or with many more than two beams, without departing from the principles to be described below.

SLM 40 is subdivided into a large number of pixels, typically, hundreds, thousands, or even more. Depending on the type of SLM array used, the pixels may be, for example, phase-shifting liquid crystal display (LCD) elements, or they may be mirrors. In either case, each pixels is individually actuable to bring about a change in an optical parameter. For an LCD element, such a parameter may be, e.g., a programmable phase shift. For a mirror element, such a parameter may be, for example, displacement normal to the plane of the array. (We refer to such displacement as “piston” displacement.) In some mirror arrays, a further programmable parameter may be tilt of the mirror element about an axis parallel to the plane of the array. In some mirror arrays, it may be possible to independently program tilt about each of two independent such axes. Phase-shifting elements may be either transmissive or reflective.

As noted, each of beams 20 and 30 is projected into a spot on SLM 40. The targets which are the sources of beams 20 and 30 may be in motion relative to the optical system. Therefore, the angular direction from which beams 20 and 30 enter the optical system may vary over time. As a consequence, the corresponding spots on SLM 40 may move about in the plane of the SLM array.

Under the control of a control system to be described below and not shown in FIG. 1, the pixels of SLM 40 are configured so as to track beams 20 and 30. More specifically, the pixels are configured to define, for each spot, a power optic that substantially intercepts that spot. By a “power optic” is meant a lens or mirror that has converging or diverging power, and as a result helps to form a beam such as beam 50 or 60, as will be described below. Below, we will simply use the word “lens” to denote any such power optic. By “substantially intercepts” is meant that most or all of the light in a given spot falls within the corresponding lens.

Under the control of the control system referred to above, the configuration of SLM 40 is continuously varied in such a way that each lens continues to intercept its spot as the spot moves across the plane of the array.

As noted, each of the lenses formed in SLM 40 tracks its corresponding beam and projects it into the corresponding one of beams 50 and 60. The SLM lens may cooperate with one or more additional optical elements, not shown in FIG. 1, to form the projected beams 50 and 60.

Beams 50 and 60 impinge on beam-steering array 70. Advantageously, array 70 is an array of MEMS mirrors which are programmably tiltable and thus able to steer a reflected beam. Each of the beams projected from SLM 40 is directed onto a respective mirror element, or other steering element, of array 70. The purpose of array 70 is to project beam 50, which is incident on array 70 at a variable angle, into a fixed beam directed toward transceiver 80, and to do likewise for beam 60. It will be appreciated that in order for array 70 to project each of the variable beams that are incident on it into a fixed beam, it must track the incident beams (or equivalently, the spots on the SLM array) under the control of the control system.

When the optical system is operated as described above, transceiver 80 is operated as an optical receiver. Conversely, transceiver 80 may be operated as an optical transmitter. In that case, the optical system is operated in a manner reciprocal to that describe above. That is, MEMS array 70 is configured to direct each beam from transceiver 80 onto a selected spot on SLM array 40. Such spot, which may vary over time, is selected to correspond to a desired angle of emergence from the optical system toward a remote target. At SLM array 40, a lens corresponding to each spot is defined in the pixel elements. Each such lens tracks its corresponding spot as the tilts of the elements of MEMS array 70 are varied. Each lens of array 40 helps to project the light from its spot toward aperture lens 10, which projects the light in a collimated beam toward a selected remote target.

Details of the optical system of FIG. 1 will be discussed with reference to FIG. 2, to which attention is now directed.

As shown in FIG. 2, each of aperture lens 10 and field lens 90 lies near the focal plane of the other. A collimated beam 120 is incident on aperture lens 10 at an angle θ relative to the optical axis of the system. Lens 10 refracts beam 120 into converging beam 130, which comes to a focus near field lens 90. Lens 90 refracts beam 130 into diverging beam 140. Because the aperture lens lies in the focal plane of the field lens, the chief ray of beam 130 emerges in beam 140 parallel to the optical axis. In beam 140, the chief ray is displaced a distance a from the optical axis. This distance is a function solely of the angular coordinates which describe the direction of entry of beam 120. It should be noted that for simplicity, FIG. 2 is drawn in two dimensions. More generally, the angle of entry of beam 120 may vary in each of two angular directions.

For simplicity, SLM array 40 has been omitted from FIG. 2. However, the plane of the SLM array has been indicated by line 110.

Beam 140 forms a spot on SLM array 40. Those pixels of array 40 that lie near the spot are configured to form lens 100. As noted, the pixels of the array are reconfigurable in such a way that lens 100 follows the spot as it moves about in plane 110.

By way of illustration, we have considered optical systems in which the aperture lens and the field lens each have a focal length f of 25-100 mm, each pixel of the SLM array has a side length l of 80 μm-150 μm, and the total SLM array is a square with 32-512 pixels on a side, so that the total length d of the array is 2.6-76.8 mm. The above characteristics lead to a theoretical field of view (expressed as a half-angle θ) of 0.8°-56.9°, according to the formula

$$θ = {tan}^{- 1} ( \frac{d}{2 f} ) .$$

We have considered forming lenses approximately 1-3 mm in diameter in the SLM array, with a focal length fₘᵢₙ of about 2.3-8 mm. In general the minimum focal length that can be generated by the SLM with good optical performance is given by

$${f}_{min} = \frac{1}{12 \sqrt{10}} \frac{{l}^{2}}{λ / 40} ,$$

where λ is the wavelength of the light. Similarly the minimal number of pixels per side Nₘᵢₙ required to form the lens will be given by

$${N}_{min} = \frac{1}{12 \sqrt{10}} \frac{l}{λ / 40 F \#} ,$$

where F# is the ratio between the effective lens aperture size and the focal length. Smaller pixel sizes l are therefore desirable.

FIG. 2 depicts a simple optical system in which lens 100 operates in transmission. More typical optical systems will employ reflective SLM arrays, as will be discussed below. It will be appreciated, however, that similar principles apply and analogies to a reflective system are readily drawn.

As seen in FIG. 2, beam 140 is refracted (or of course reflected in, e.g., a mirror array) by lens 100 to form collimated beam 150. Thus, the continuous angular variation of large collimated input beam 120 is converted to continuous spatial variation (i.e., in the lateral directions relative to SLM array 40) of a small collimated output beam.

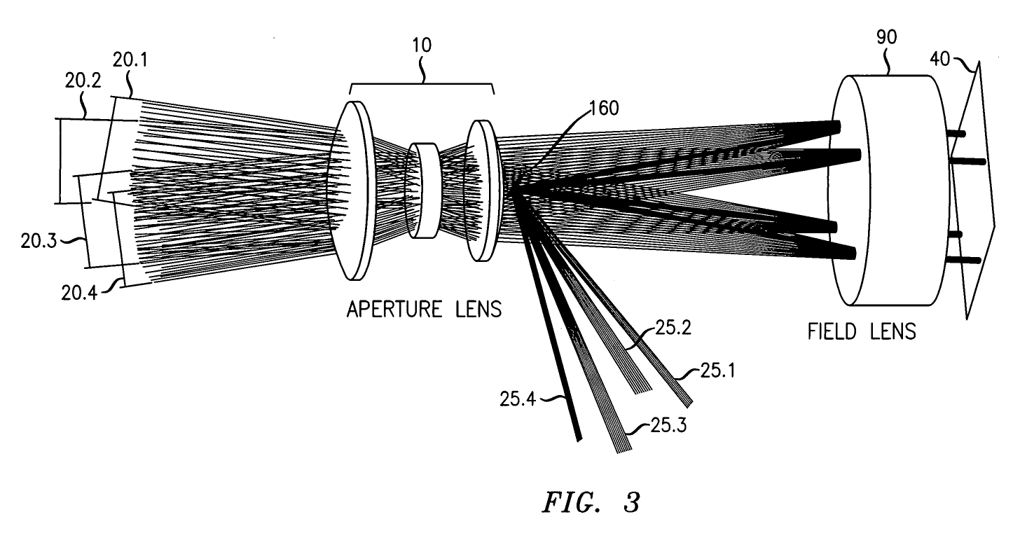

A more complex optical system is illustrated in FIG. 3. Here, four incident beams 20.1-20.4 are shown as projected by aperture lens 10 and field lens 90 into spots on SLM 40. In FIG. 3, SLM 40 operates in reflection. Accordingly, individual collimated beams, one from each spot, are reflected from SLM 40 and re-enter field lens 90. In turn, lens 90 focuses each beam onto coupling mirror array 160, which is situated just behind aperture lens 10. Mirror array 160 has at least as many individual mirror elements as there are beams impinging on it from field lens 90.

If all of the beams reflected from SLM 40 were reflected perfectly parallel to the optical axis, they would all be brought to a single focal point where mirror array 160 intercepts the optical axis. This, however, is undesirable. Each of the beams that impinge on mirror array 160 has an angle of incidence on array 160 that may vary over time as the corresponding target moves in space (relative to the optical system) and concomitantly as the corresponding spot moves in the plane of SLM 40. However, it is advantageous to map each of the impinging beams onto a fixed output path, e.g., as represented by output beams 25.1-25.4 in FIG. 3. Because the motion of each of the beams that impinge on array 160 is independent of the others, the desired mapping can be accomplished only if each beam impinges on a respective mirror element of the array, which can be configured independently of the other mirror elements. (Of course a “respective mirror element” may be a group of individual mirror elements acting together.)

As noted, the beams that impinge on array 160 would impinge on a common focal spot if they were all parallel to the optical axis as reflected from SLM 40. To prevent this from happening, and instead to direct each beam to a respective mirror element of array 160, the pixels of SLM 40 should be configured to provide additional beam steering. Such steering can be provided, e.g., by programmed phase shifts or by programmed tilt of mirror elements. At each spot on SLM 40, the pixels that form the corresponding lens are thus additionally configured to direct the reflected, collimated beam at an angle to the optical axis, selected so that the beam will come to a focus on the desired mirror element of array 160.

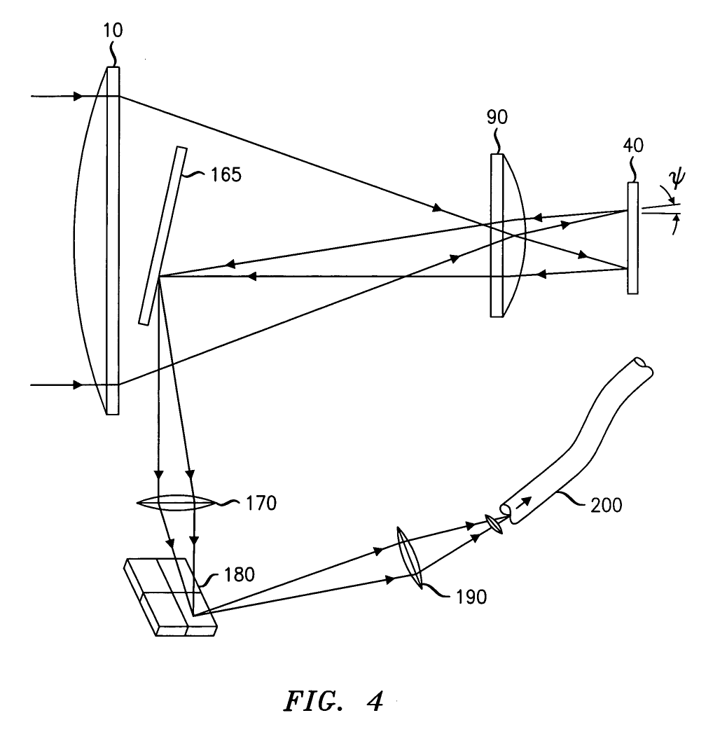

As described above and shown in FIG. 3, array 160 is situated behind the aperture lens. Alternatively, as illustrated in FIG. 4, a fixed mirror 165 may be placed behind the aperture lens to reflect the beams from the SLM array through, e.g., focusing lens 170, onto actuable mirror array 180, which is situated away from the axis of the aperture lens. In FIG. 4, a beam is shown reflected from SLM 40 at an angle ψ to the optical axis, and brought to a focus on a portion of mirror 165.

Each beam reflected from mirror 165 is imaged by lens 170 onto an individual mirror element of array 180. By appropriately tilting the pertinent mirror elements, each beam reflected from array 160 or array 180 can be directed into a selected optical fiber. Thus, for example, the figure shows a beam reflecting from mirror 165, impinging on array 180, and entering lens 190, which focuses the beam into lensed optical fiber 200.

Conversely, if the optical system is operated in transmission instead of reception, light output from selected optical fibers, or directly from one or more lasers, can be coupled onto array 160 or array 180 and directed from there to a selected spot on SLM 40, as explained above. An actual mirror array useful in this regard can be based, for example, on the LambdaRouter optical switch, which is available from Lucent Technologies, 600 Mountain Avenue, Murray Hill, N.J. 07974. For at least some applications, SLM 40 can also be realized using a mirror array of the LambdaRouter optical switch.

As noted, for at least some applications, SLM 40 may be implemented in a phase-shift LCD array. The capabilities of such arrays are described, for example, in the following articles: Y. Suzuki, “Spatial light modulators for phase-only modulation,” Technical Digest of the Pacific Rim Conference on Lasers and Electro-Optics, vol. 4, Seoul, Korea (Aug. 30-Sep. 3, 1999), 1312-1313; and D. Casasent, “Spatial light modulators,” Proc. IEEE, Vol. 65 (January 1977), 143-157.

As noted above, SLM 40 and array 160 are operated under the control of a control system which is arranged to track the spots on SLM 40, configure SLM 40 to direct the reflected beams (or, in alternative arrangements, the transmitted beams) to individually assigned mirror elements of array 160, and configure the elements of array 160 to direct each impinging beam onto a fixed path. In order to perform these control functions, the controller must rely upon input from sensing devices to tell it the current locations of the spots on SLM 40 (or equivalent information). Advantageously, the controller is also provided with information useful for precisely aligning the beams reflected from array 160 for injection into optical fibers.

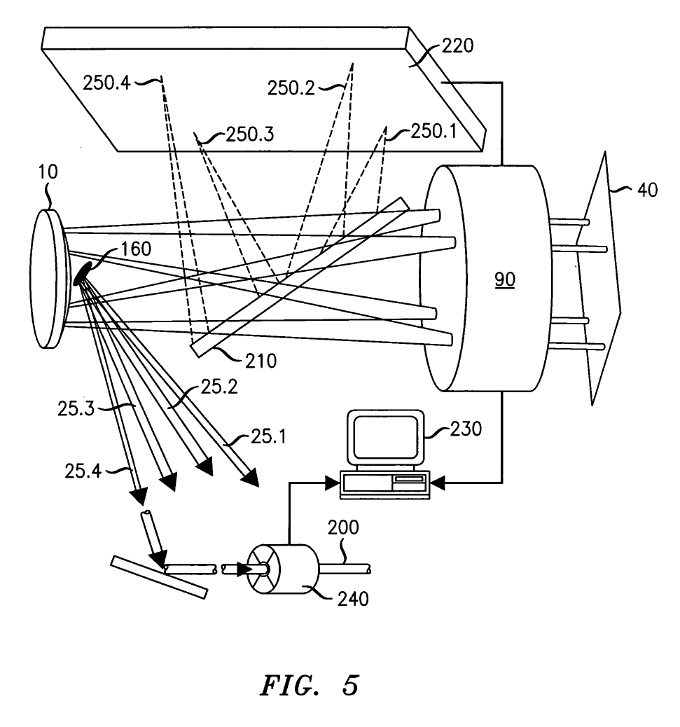

Accordingly, as shown in FIG. 5, a controller 230 is arranged to receive input data from four-quadrant diode arrays 240 and CCD camera 220. It is advantageous to provide a quadrant diode array arranged concentrically with the entrance aperture of each fiber 200 which is to receive a light beam relayed by array 160. The four-quadrant diode array provides a signal derived from the relative responses of four diode elements arranged in a concentric pattern about the optical fiber. This signal is indicative of the fine alignment of the optical beam with the fiber. In a similar manner, it is advantageous to provide each mirror element of array 160 with a four-quadrant diode array (not shown) to provide data to the controller for use in optical alignment.

In one possible arrangement, partially reflective planar mirror 210 is interposed in the optical path between Aperture lens 10 and field lens 90. CCD camera 220 is placed in the focal plane of lens 10 with respect to the optical path which is folded by mirror 210, an optional second field lens 230 similar to 90 may also be inserted after the partially reflective mirror 210 and the CCD camera 220. Accordingly, a spot pattern will form on the CCD camera which corresponds to the spot pattern formed on SLM 40. In FIG. 5, the formation of the spot pattern on the CCD camera is indicated by rays 250.1-250.4, which are the chief rays of the respective beams reflected by mirror 210.

From the spot pattern detected by the CCD camera, the controller can readily compute the positions of the spots on SLM 40. From this information and from information provided by the four-quadrant diodes at array 160, all of the various adjustments of pixels and array elements discussed above can be computed, except possibly for those related to fine adjustments in the alignment of the output beams, such as beams 25.1-25.4 of FIG. 5. After coarse alignment has been carried out, the output from the four-quadrant diodes can be used for the fine adjustments, particularly of array 160.

An exemplary control scheme for using the optical system in transmission operates in two loops. A faster loop computes, in real time, the positions of the SLM lenses. Because such a computation may involve high data rates and intense demand on computational resources, it will in at least some cases be advantageous to implement it using a field-programmable gate array (FPGA). A slower loop, which may be controlled, e.g., by a digital signal processor (DSP) or microcontroller, computes the optimal alignments of the mirror elements of array 160.

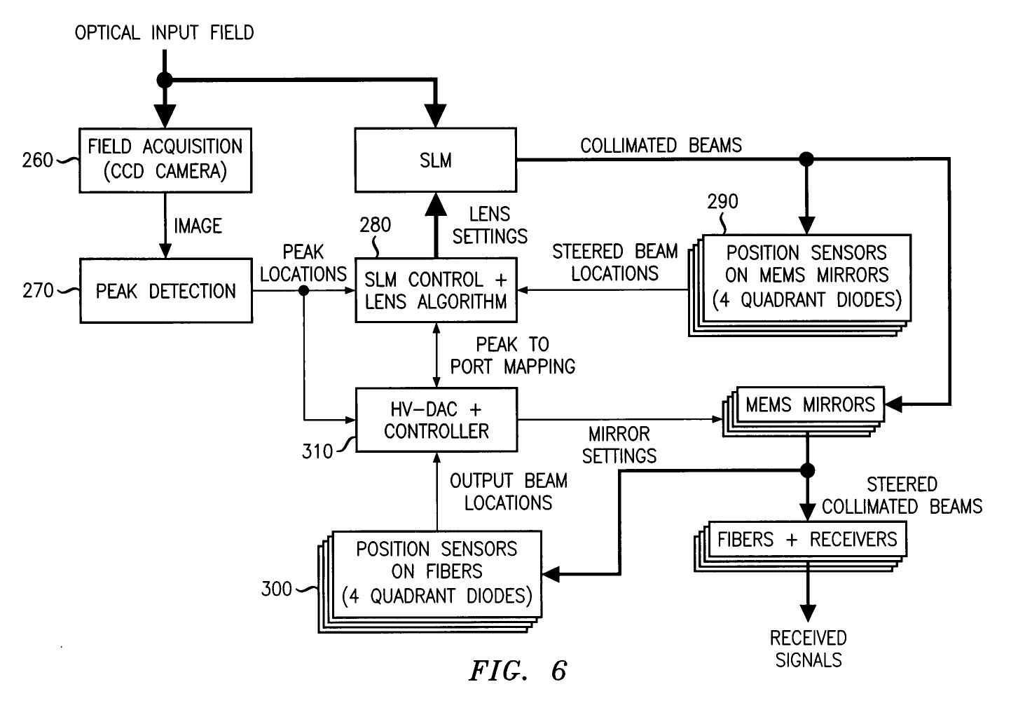

The control scheme will now be described in more detail with reference to the functional block diagram of FIG. 6.

At block 260, a CCD camera captures the current positions of the spots on the SLM, or equivalent information. At block 270, the spots are precisely located by an algorithm for detecting the peak positions of the illumination pattern. Such an algorithm may be usefully implemented in, e.g., an FPGA, an application-specific digital circuit (ASIC), or a digital signal processor (DSP). At block 280, the control device for the SLM uses the peak-location data to compute the positions of the SLM lenses. At block 290, the four-quadrant diodes on the mirror elements of array 160 provide information indicative of the alignment of the beams steered by the SLM. This information is also used by the SLM control for the lens computation at block 280. As noted, the SLM control is advantageously implemented in an FPGA.

At block 300, the four-quadrant diodes at the optical fibers provide information indicative of the alignment of the output beams on the fibers. This information is provided to the controller for mirror array 160, which is implemented, e.g., in a digital signal processor (DSP) or in a personal computer operating under control of an appropriate software program. As shown in the figure, the mirror controller also receives information about the peak locations, and makes use of a “peak-to-port” mapping which relates each spot on the SLM to a respective optical output port. An optical output port may correspond, e.g., to a particular optical fiber.

At block 310, the mirror controller uses the information about peak locations, the information about alignment with the optical fibers, and the peak-to-port mapping to compute adjustments to the alignment of the mirror elements of array 160. If, e.g., the mirror array is a MEMS array, the mirror elements will typically be actuated by voltage waveforms generated by a high-voltage digital-to-analog converter (HV-DAC) operating under control of the mirror controller.

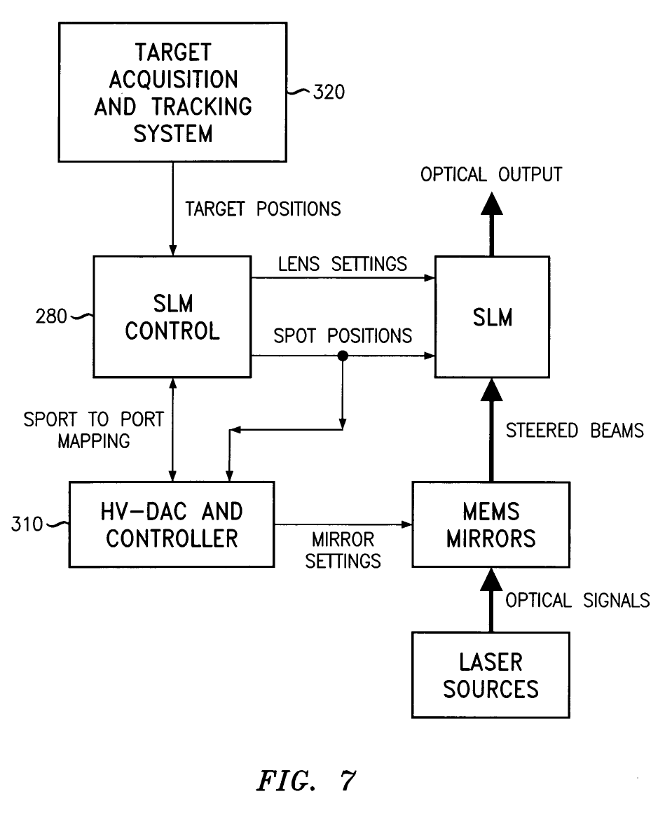

A simple control scheme for operating the optical system in transmission will now be described with reference to FIG. 7. A system as indicated at block 320 acquires the desired targets and tracks them as they move through space. System 320 provides the positions of the targets, as they vary over time, to SLM control 280 and mirror-array controller 310. From the target-position data, the SLM control computes the position of one spot on the SLM to correspond to each desired target. Thus, if a laser source were aimed at a particular computed spot on the SLM, a lens situated at that spot would cause the laser light to be reflected into the field lens and the aperture lens in such a way as to form a beam aimed at the corresponding target.

The SLM control provides the control data needed by the SLM to form an appropriate lens at each spot, and to move the spots so as to track the desired targets.

The lens settings provided to the SLM control include corrections to assure that each lens will be optically coupled to a selected one of the mirror elements of array 160.

As indicated in the figure, the SLM control and the controller for array 160 (which, as noted, may be a MEMS mirror array) agree on a set of mappings which relate each spot to a given optical port. A “port” in this regard may be, e.g., a laser acting as a source of an optical signal to be transmitted, or it may be, e.g., an output port of an optical cross-connect coupled to one or more such source lasers.

As indicated at block 310, the controller uses the computed spot positions and the spot-to-port mapping to compute appropriate configurations of the mirror elements of array 160, and controls a high-voltage waveform to actuate the mirror elements.

It will be appreciated that various other arrangements may be used to improve the performance of the optical transmission described above. For example, a CCD camera may be provided for tracking the spots on the SLM, and four-quadrant diode arrays or the like may be provided for sensing the optical alignment of the mirror elements of array 160.

A further benefit of the configurable lenses formed in the SLM array is that the focal length of the array lenses is controllable. As a consequence, the beam divergence and the acceptance angle of the optical system can be varied. Such an ability is especially useful for, e.g., initial alignment with respect to external stations.

It will be appreciated that the principles outlined above in regard to an illustrative embodiment of the invention can also be applied in numerous alternative optical arrangements. For example, optical arrangements can be devised, which omit field lens 90 and employ a focusing element in place of aperture lens 10 to directly focus input light onto the SLM array. Such an arrangement is of greatest interest in combination with an SLM array that provides pixels with relatively large tip/tilt angles.

In other examples, mirror array 160 (or mirror 165) is moved away from the common axis of lenses 10 and 90. This can be achieved, e.g., by tilting SLM array 40, or by introducing a solid prism between aperture lens 10 and SLM array 40. This can also be achieved by introducing a beam splitter, such as a polarization dependent beam splitter, between the aperture lens and the SLM array, and using it to separate the incoming beam from the reflected beam.

In other examples, an array of optical receivers, or an array of optical multimode fibers takes the place of mirror array 160. In this case, optical coupling of input beams into a fixed path toward a receiver is effectuated by the lenses formed in the SLM array, without tracking by a mirror array.

In the illustrative embodiment described above, the smallest resolvable angle between beams from external stations is limited by the spot size on SLM array 40. The minimal resolvable angle may be reduced further by adding a second SLM array which, like array 40, can be configured with individual lenses. The lenses formed in the second SLM array would combine with respective lenses of array 40 to improve the overall optical performance. The second SLM array could be placed, for example, at the location of mirror array 165 as illustrated in FIG. 4, and operated so as to reflect the beams to an outlying mirror array such as array 180 of FIG. 4.

In still other examples, wavelength-division multiplexing (WDM) is used to increase the potential number of communication channels per resolvable spot on the SLM array. Turning back to FIG. 5, instead of coupling a beam from array 160 directly into fiber 200, the beam may instead be coupled into a wavelength demultiplexer which directs the beam, according to its wavelength, to one of a plurality of output ports, and from there to an optical fiber or optical detector. Even greater flexibility can be achieved by coupling the beam into a wavelength-selective optical switch for direction to an output port determined according to wavelength and the programming of the switch. In transmission, laser light in multiple wavelength channels can be multiplexed onto a beam to array 160 in the converse of the process described above.

What is claimed is:

1. Apparatus comprising:
a spatial light modulator (SLM);
a projective optical subsystem configured to optically couple at least one external station to a corresponding spot on the SLM;
a relay optical subsystem comprising at least one beam-steering element which is actuable so as to optically couple at least one said spot to an optical source or optical receiver, wherein the spot is coupled to the relay optical subsystem on a path that may vary over time, and coupled to the source or receiver on a path that is substantially fixed; and
control circuitry effective for configuring a lens pattern in the SLM in the vicinity of at least one said spot, wherein the lens pattern tracks the spot and is configurable to at least partially effectuate optical coupling between the projective optical subsystem and the relay optical subsystem.

2. Apparatus of claim 1, wherein the relay optical subsystem comprises a plurality of independently configurable beam-steering elements, and the lens pattern in the SLM is configurable to simultaneously optically couple two or more spots to two or more distinct, respective beam-steering elements.

3. Apparatus of claim 2, wherein the beam-steering elements of the relay optical subsystem are elements of a mirror array.

4. Apparatus of claim 1, wherein:
the projective optical subsystem comprises an aperture lens and a field lens arranged along an optical axis; and
the aperture lens and field lens are arranged such that in operation, the optical path between an external station and the SLM will include at least a first beam and a second beam, wherein the first beam goes between the external station and the aperture lens and has a variable angular direction, and the second beam goes between the field lens and the SLM and has a fixed angular direction parallel to the optical axis.

5. Apparatus of claim 4, wherein the SLM is arranged to receive incident light through the field lens, and each lens pattern in the SLM is configurable to reflect light from its corresponding spot back through the field lens toward the relay optical subsystem or toward the aperture lens.

6. Apparatus of claim 5, wherein the field lens and the aperture lens each lie in a focal plane of the other, and one or more beam-steering elements of the relay optical subsystem are situated in a focal plane of the field lens.

7. Apparatus of claim 1, further comprising a CCD camera arranged to detect the position of at least one said spot and provide data relating to the spot position to the control circuitry.

8. Apparatus of claim 1, configured for receiving optical signals from external stations, in that:
the projective optical subsystem is configured to project light received from at least one external station into a corresponding spot on the SLM;
at least one said beam-steering element of the relay optical subsystem is actuable so as to receive light from at least one said spot at a variable angle of incidence and to steer the received light onto a substantially fixed path; and
the control circuitry is effective for tracking at least one said spot and configuring a lens pattern in the SLM in the vicinity of the tracked spot, such that the lens pattern is configurable to direct light from the corresponding spot onto a path to the relay optical subsystem.

9. Apparatus of claim 8, further comprising an optical receiver optically coupled to the relay optical subsystem so as to receive light from the substantially fixed path.

10. Apparatus of claim 9, wherein the receiver is optically coupled to the relay optical subsystem through at least one optical fiber.

11. Apparatus of claim 8, wherein:
the projective optical subsystem comprises an aperture lens and a field lens arranged along an optical axis; and
each lens pattern in the SLM is configurable to reflect light from its corresponding spot back through the field lens toward the relay optical subsystem.

12. Apparatus of claim 11, wherein the SLM is configurable such that the back-reflected light from each said spot forms a collimated beam before it re-enters the field lens.

13. Apparatus of claim 1, configured for transmitting optical signals to external stations, in that:
the projective optical subsystem is configured to project light received from at least one spot on the SLM into a beam directed toward an external station;
the relay optical subsystem comprises at least one beam-steering element which is actuable so as to receive light from at least one laser light source on a substantially fixed path and to steer the light onto a designated spot on the SLM having a variable position; and
the control circuitry is effective for computing a position for at least one said spot which is variable over time, and for configuring a lens pattern in the SLM in the vicinity of the computed spot position, wherein the lens pattern is configurable to direct light from the corresponding spot onto a path to the projective optical subsystem for projection in the beam directed to the external station.

14. Apparatus of claim 13, further comprising a target acquisition and tracking subsystem arranged to detect the position of at least one external station and provide data relating to the detected position to the control circuitry.

15. A method for receiving an optical transmission from at least one external station, comprising:
collecting transmitted light from at least one said station and directing it onto a spot on a spatial light modulator (SLM);
configuring a lens pattern in the SLM in the vicinity of at least one said spot, such that the lens pattern tracks the spot and such that light is directed from the or each spot to a beam-steering element; and
actuating at least one said beam-steering element so as to track a corresponding spot and direct light from the tracked spot into a substantially fixed path toward an optical receiver.

16. The method of claim 15, wherein transmitted light is collected from two or more external stations and directed onto two or more spots, each spot corresponding to a respective station, and the actuating step comprises actuating each of two or more independently configurable beam-steering elements so as to simultaneously track each said spot with a respective beam-steering element.

17. The method of claim 15, wherein light from the external station is collected from a variable angular direction and directed onto the SLM in a beam having a fixed angular direction.

18. The method of claim 15, wherein the lens pattern is configured to accept light from the external station in a converging beam and reflect it in a collimated beam toward the beam-steering element.

19. The method of claim 15, further comprising: detecting the position of at least one said spot in a CCD camera, obtaining from the CCD camera data relating to the spot position or positions, and using said positional data for controlling the configuration of the lens pattern.

20. A method for transmitting an optical signal to at least one external station, comprising:.
computing a time-variable position for at least one spot on a spatial light modulator (SLM) which is representative of an angular direction to a corresponding external station;
actuating at least one beam-steering element so as to track a corresponding spot and direct light received on a substantially fixed path from a laser light source to the tracked spot; and
configuring a lens pattern in the SLM in the vicinity of at least one tracked spot, such that the lens pattern tracks the spot and directs light from the spot toward the external station.

21. The method of claim 20, wherein optical signals are transmitted to two or more external stations from two or more spots on the SLM, each spot corresponding to a respective station, and the actuating step comprises actuating each of two or more independently configurable beam-steering elements so as to simultaneously track each said spot with a respective beam-steering element.

22. The method of claim 20, wherein light is transmitted from the SLM into a projective optical system in a beam having a fixed angular direction, and directed by the projective optical system to the external station in a beam having a variable angular direction.
